(19) United States
(12) Patent Application Publication
(10) Pub. No.: US 2012/0082531 A1
(43) Pub. Date: Apr. 5, 2012

(54) METHOD AND SYSTEM FOR CENTERING A CRUCIBLE IN A FURNACE

(75) Inventors: David F. Broyer, Kingston, NH (US); Brett R. Schuster, Milford, NH (US)

(73) Assignee: GT ADVANCED TECHNOLOGIES INC., Merrimack, NH (US)

(21) Appl. No.: 13/248,709

(22) Filed: Sep. 29, 2011

Related U.S. Application Data
(60) Provisional application No. 61/388,290, filed on Sep. 30, 2010.

(51) Int. Cl. F27D 3/02; B65G 67/16

(52) U.S. Cl. 414/154; 414/804

(57) ABSTRACT

A method and system for loading and centering a crucible in a furnace is disclosed. The method comprises, in part, the steps of centering a rail loader over a furnace bottom; placing the crucible on the rail loader; and moving the crucible over the crucible block in the center of the furnace bottom. A rail loader system that is capable of centering the crucible in the furnace is also disclosed.

### CROSS-REFERENCE TO RELATED APPLICATIONS

The present application claims the benefit of U.S. Provisional Patent Application No. 61/388,290, filed Sep. 30, 2010.

### BACKGROUND OF THE INVENTION

1. Field of the Invention

The present invention relates to methods and apparatuses for loading a crucible into a furnace.

2. Description of the Related Art

Crystallization furnaces, such as directional solidification systems (DSS) and heat exchanger method (HEM) furnaces, involve the melting and controlled resolidification of a feedstock material, such as silicon, in a crucible. Typically, a crucible containing feedstock material, often contained within a graphite crucible box, is placed into the furnace and heated in order to fully melt the feedstock. The melted feedstock is then allowed to solidify under controlled conditions, thereby producing a solid feedstock in the crucible, sometimes referred to as an ingot. By controlling how the melt solidifies, an ingot having greater purity than the starting feedstock material can be achieved, which enables the feedstock material to be used in a variety of high end applications, such as in the semiconductor and photovoltaic industries.

A challenge for this process is to ensure that the crucible is placed in the center of the solidification furnace, which is necessary in order to provide consistent and controlled heating during both the melting stage as well as the solidification stage, to thereby form high quality ingots. For example, typically, the crucible is contained in a graphite crucible box and filled with feedstock material. This is often very heavy and difficult to easily lift and move into position within the furnace. Furthermore, the crucible block upon which the crucible is placed to raise above the floor of the furnace often rests upon several pedestals and is sometimes off center as a result of variances in construction and leveling. Thus, loading the crucible into the center of the furnace, while also ensuring that the crucible block is also in the center of the furnace, is difficult to attain repeatedly and easily.

Various methods and devices are known that enable the user to position the crucible in the center of the furnace. However, these are often very time consuming and require multiple operators to properly position the crucible. Furthermore, the industry is moving to the use of larger crucibles for processing increased amounts of feedstock material. Heavier and larger crucibles are much more difficult to maneuver, and thus, there is an increasing need in the industry for a simple, reliable, and repeatable method and device for loading a crucible in the center of a furnace.

### SUMMARY OF THE INVENTION

The present invention relates to a method of loading a crucible in a furnace. The method comprises the step of providing a crucible in a crucible box, a furnace bottom, and a rail loader system. The crucible box comprises at least one side plate and a bottom plate. The furnace bottom comprises a crucible block and a base. The rail loader system comprises a) a rail loader, which comprises a receiving section and a loading section joinable with the receiving section, wherein the loading section comprises at least one block centering device, at least two rails having multiple rollers, at least one opposing pair of self-centering devices, and a base centering device, and b) a shuttle device comprising a carriage unit on a shuttle. The method further comprises the step of centering the rail loader over the furnace bottom by i) placing the loading section and the receiving section along opposite sides of the furnace bottom, along with engaging the base centering device with the base of the furnace bottom, and ii) joining the loading section and the receiving section together. The method further comprises the steps of centering the crucible block within the rails of the loading section with the block centering device; placing the crucible in the crucible box onto the carriage unit of the shuttle device and placing the shuttle device onto the at least one opposing pair of self-centering devices of the loading section of the rail loader; sliding the carriage unit along the rails of the loading section and over the crucible block in the furnace bottom; and centering the carriage unit over the crucible block. Finally, the method further comprises the step of raising the furnace bottom to contact the crucible block with the crucible in the crucible box.

The present invention further relates to a rail loader system, which can be used in the method of the present invention. The rail loader system comprises 1) a rail loader which comprises a receiving section and a loading section joinable with the receiving section, wherein the loading section comprises at least one block centering device, at least two rails having multiple rollers, at least one opposing pair of self-centering devices, and a base centering device; and 2) a shuttle device comprising a carriage unit on a shuttle. Optionally, the rail loader system of the present invention further comprises a charge loading station, which comprises an upper frame and a lower frame and wherein the upper frame is smaller than the lower frame.

It is to be understood that both the foregoing general description and the following detailed description are exemplary and explanatory only and are intended to provide further explanation of the present invention, as claimed.

### BRIEF DESCRIPTION OF THE DRAWING

FIG. 1 is a top view of an embodiment of the rail loader system of the present invention.

FIG. 2 is a top view of an embodiment of the rail loader of the rail loader system of the present invention.

FIG. 3 is an isometric view of an embodiment of the loading section and shuttle device of the rail loader system of the present invention.

FIG. 4 is an isometric view of an embodiment of the loading section of the rail loader system of the present invention.

FIG. 5 is an isometric view of an embodiment of the self-centering device of the rail loader system of the present invention.

FIG. 6 is an isometric view of an embodiment of the shuttle device of the rail loader system of the present invention.

FIG. 7 is an isometric view of an embodiment of the charge loading station of the rail loader system of the present invention.

### DETAILED DESCRIPTION OF THE INVENTION

The present invention relates to methods and systems for centering a crucible, particularly a large, filled crucible, in a furnace.

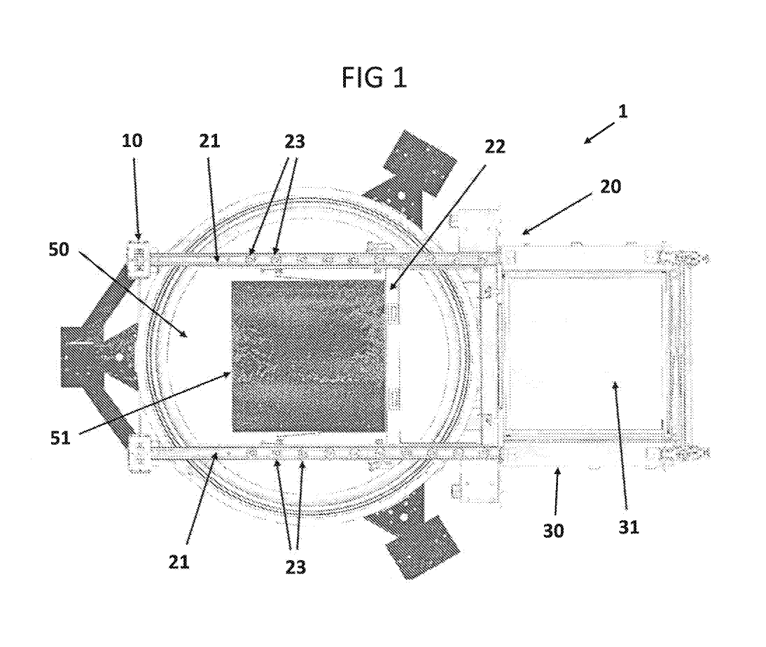

The method of the present invention comprises the steps of providing a crucible, a furnace bottom, and a rail loader system which comprises a rail loader and shuttle device; centering the rail loader over the furnace bottom; placing the crucible on the rail loader; and moving the crucible over the center of the furnace bottom. Each of these will be discussed in more detail below. Particular reference will be made to the embodiments of the rail loader system shown in the FIG. 1-FIG. 7. However, it should be apparent to those skilled in the art that these are merely illustrative in nature and not limiting, being presented by way of example only. Numerous modifications and other embodiments are within the scope of one of ordinary skill in the art and are contemplated as falling within the scope of the present invention. In addition, those skilled in the art should appreciate that the specific parameters and configurations shown in FIG. 1-FIG. 7 are exemplary and that actual parameters and/or configurations will depend on the specific systems available. Those skilled in the art will also be able to recognize and identify equivalents to the specific elements shown, using no more than routine experimentation.

The crucible used in the method of the present invention can be any container known in the art for holding, melting, and resolidifying a feedstock material. For example, for silicon, quartz crucibles are typical. It is preferred that the crucible is contained within a crucible box to provide added stability and rigidity. The crucible box comprises at least one side plate and a bottom plate, and may optionally further comprises a lid. For example, for a square crucible, the box is also square, having four walls and a bottom plate, with an optional lid.

The furnace into which the crucible is placed can be any device or apparatus used to heat and melt a feedstock material, such as silicon, generally at temperatures greater than about 1000° C., and subsequently to promote resolidification of the melted feedstock material, including but not limited to crystal growth furnaces and directional solidification (DSS) furnaces. Typically, such a furnace is provided in two parts—a furnace top and a furnace bottom—which are separated in order to gain access to the interior of the furnace, for example, to load a crucible therein. The inside of the furnace bottom comprises a crucible block, preferably raised upon multiple pedestals or posts. The crucible block and pedestals can be made of any material known in the art capable of withstanding the temperatures and conditions within the furnace, including, for example, graphite. The outside of the bottom of the furnace comprises a base, upon which the furnace bottom sits.

The rail loader system used in the method of the present invention comprises multiple units and/or sections. In particular, the rail loader system comprises a rail loader, which comprises a receiving section and a loading section, and a shuttle device, which comprises a carriage unit on a shuttle. The receiving section of the rail loader is joinable with the loading section, and vice-versa, and the shuttle device is capable of being placed and self-centered on the loading section. Specific embodiments of each are shown in FIG. 1-FIG. 5.

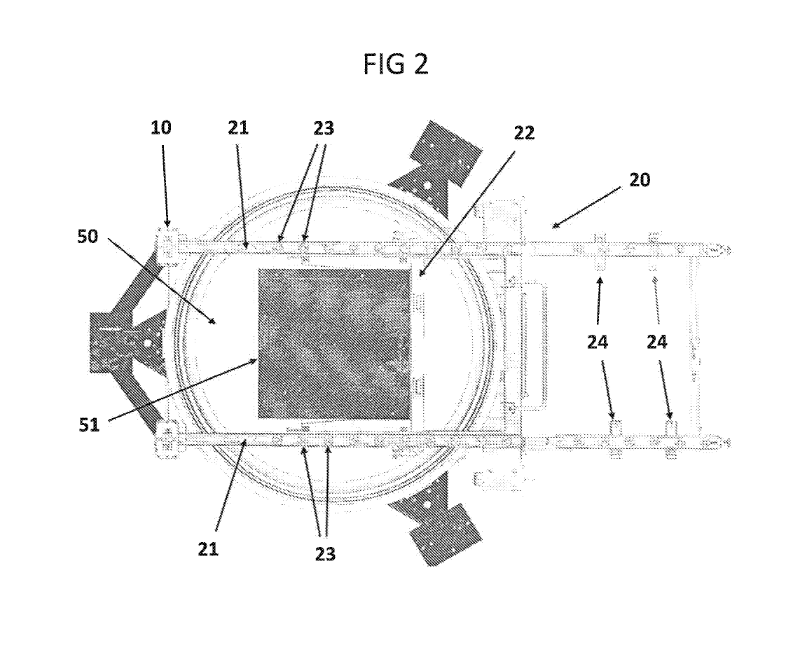

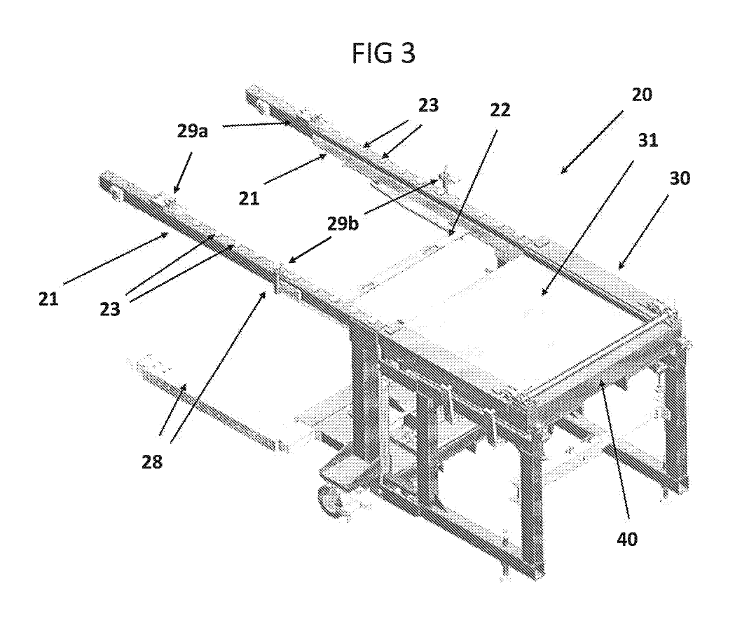

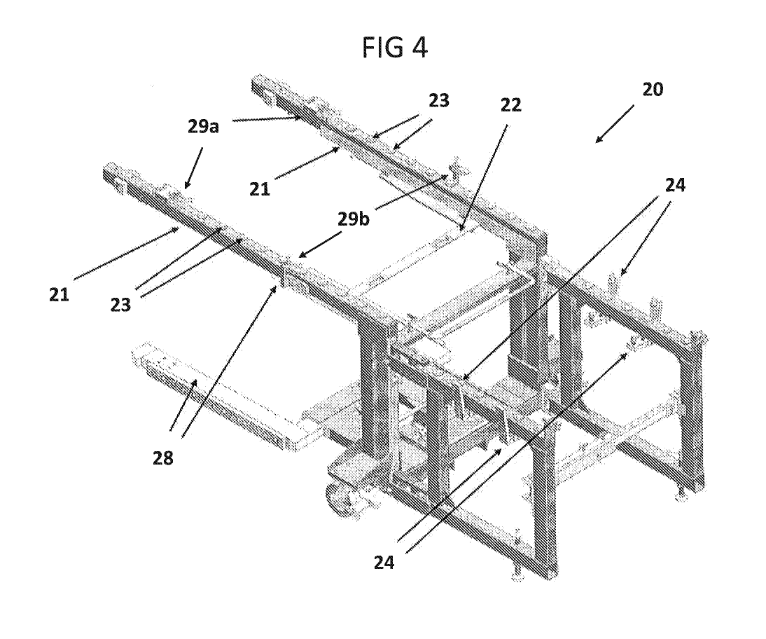

Thus, as shown in FIG. 1, the rail loader system comprises a rail loader, 1 comprising receiving section 10 and loading section 20, along with shuttle device 30 comprising carriage unit 31 on shuttle 40 (not visible). As shown, the shuttle device, comprising the carriage unit and shuttle, are both placed upon loading section 20. FIG. 2 shows the rail loader of this rail loader system (i.e., without shuttle device 30). FIG. 3 shows loading section 20 with shuttle device 30, which comprises carriage unit 31 on shuttle 40, and FIG. 4 shows the same loading section, without the carriage unit or shuttle. Thus, as can be seen, loading section 20 has, at one end, components that enable the loading section and receiving section to be joined and connected, and, at the other end, an area upon which the shuttle device may be placed. This loading area can either be permanent or, preferably, can be formed by swinging frame sections that can be opened outwardly to form the sides of the loading area and then locked together with a locking bar to stabilize the loading area in order to accept the shuttle device.

As shown in FIG. 1 and FIG. 2, loading section 20 comprises at least two rails 21 and at least one block centering device 22 that is used to center crucible block 51 located in furnace bottom 50. Preferably, the block centering device has a shape that fits the outer dimensions of the crucible block in the furnace bottom. For example, if the crucible block is square, the block centering device preferably has a shape that fits against this shaped block, such as around at least three of the crucible block edges. In addition, preferably, block centering device 22 is located between rails 21. For example, if the loading section comprises two rails, the block centering device is preferably in between these rails and is movable along at least part of the length of the rails.

The rails of the loading section have at least one means for easily and smoothly sliding a heavy object along them. For example, as shown in FIG. 1-FIG. 4, rails 21 comprise multiple rollers 23, such as bearings, which freely rotate or roll as an object is moved over them. Other means known in the art can also be used. Preferably, at least one rail further comprises at least one carriage stop 29a and at least one latch 29b. The carriage stops and latches can be adjustable along the rails, allowing them to be placed at preset positions along the rail and secured thereon.

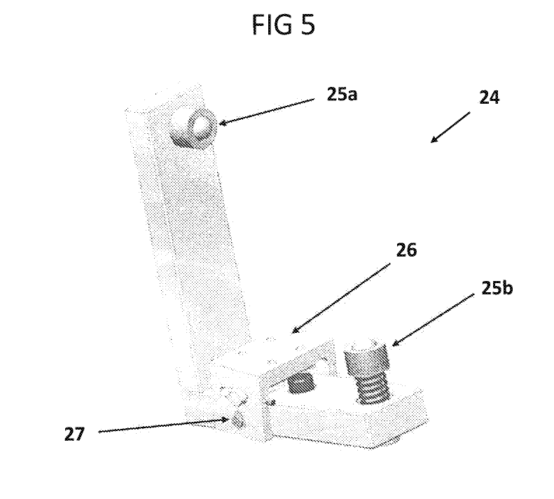

The loading section further comprises at least one opposing pair of self-centering devices 24, with one member of the pair on opposite sides of the loading section, such as either front to back or side to side. Preferably, for ease of centering, the loading section comprises two opposing pairs of self-centering devices which are located on opposite sides of the loading section, and a specific embodiment is shown in FIG. 2 and FIG. 4. These self-centering devices may have a variety of different shapes and designs and can further be made of a variety of different materials that will be known to one of skill in the art. As a specific example, the self-centering device may have a top bearing and a lower bearing and be attached to the loading section in such a way that the device pivots when a weighted object, such as a loaded crucible, is placed thereon. FIG. 5 shows a specific embodiment of such a self-centering device which is L-shaped, having top bearing 25a and lower bearing 25b. This can be attached to loading section 20 at bracket 26, thereby allowing the self-centering device to pivot along pivot point 27.

Loading section 20 further comprises at least one base centering device, which fits or attaches to the base of the furnace bottom. For example, as shown in FIG. 3 and FIG. 4, loading section 20 comprises furnace guides 28 that fit along the outside of the furnace bottom. In addition, or alternatively, an inner furnace guide (not shown) which fits into an interior portion of the base of the furnace bottom may be used to center loading section 20 to the furnace base. Latches or other attachment means may also be used to lock the loading section, once centered, in place over the furnace bottom.

The shuttle device of the rail loader system comprises a carriage unit and a shuttle. The carriage unit of the shuttle device is capable of being placed on and/or attached to the top of the shuttle but is not permanently attached thereto, which therefore allows the carriage unit to be removed, such as by sliding or rolling the carriage unit off of the shuttle. For example, the carriage unit and shuttle may comprise matching sections or components which fit together to hold them in place, keeping the carriage unit of the shuttle device on the shuttle and allowing it to be transported or moved. However, these components may be removed or disconnected, allowing the carriage unit to be moved from the shuttle. Furthermore, the carriage unit of the shuttle device may be appropriately shaped to accept the crucible. Preferably, the carriage unit has a partial pan shape, with a depth sufficient to accept and secure the crucible, with or without a box. Additional shims or bumpers may be used to further secure the crucible and box, if used.

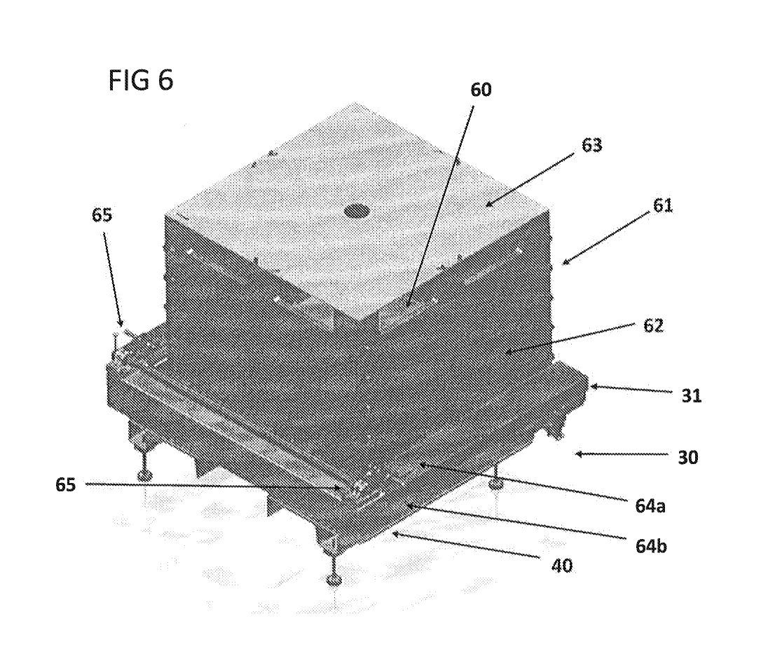

For example, as shown in FIG. 6, crucible 60 in crucible box 61 having side plates 62, lid 63, and a bottom plate (not visible) rests on and partially within carriage unit 31 of shuttle device 30, which sits upon shuttle 40. Carriage unit 31 fits onto shuttle 40 using matching components 64a and 64b. Carriage unit 31 can be locked onto shuttle 40 using latches 65, although other connecting means can also be used. This can subsequently be disconnected, allowing carriage unit 31 to freely slide along matching components 64a and 64b. Additional means for sliding, such as rollers or bearings, may also be used.

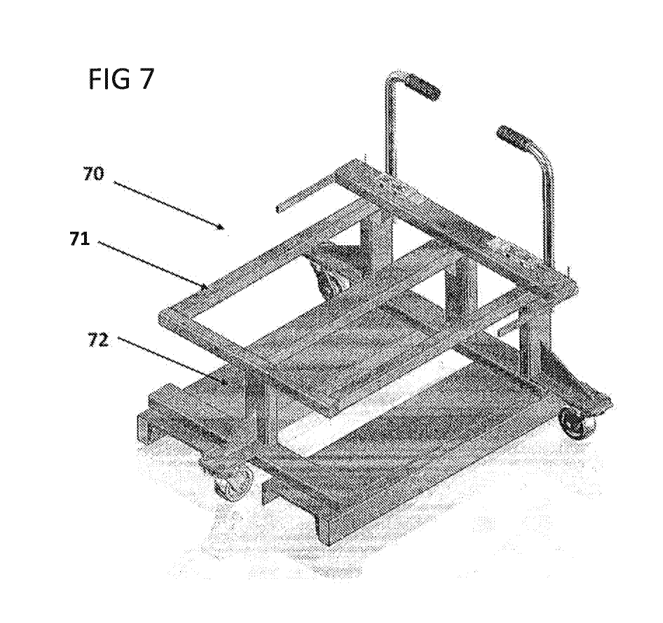

Optionally, the rail loader system used in the method of the present invention further comprises a charge loading station, which can be used for charging or filling the crucible with feedstock material. Preferably, the charge loading station is designed so that it can be joined with the carriage unit and/or shuttle device in order to transfer the filled crucible thereon. For example, as shown in FIG. 7, charge loading station 70 can comprise upper frame 71 and lower frame 72, with upper frame 71 being smaller than lower frame 72 and also smaller than the bottom of a crucible or bottom plate of a crucible box. In this way, a crucible can be filled while resting on upper frame 71, with the bottom of the crucible or bottom of the crucible box overhanging the frame. This can then be transferred to the carriage unit and/or shuttle device using any equipment known in the art. For example, if the carriage unit of the shuttle device has an inner opening matching the dimensions of the upper frame of the charge loading station, then the shuttle device may be slid under the crucible on the upper frame and raised to lift the crucible and box, if used, which overhangs the upper frame, thereby transferring the crucible from the charge loading station to the shuttle device. Other methods may also be used.

In the method of the present invention, the rail loader is centered over the furnace bottom by placing the receiving section on one side of the furnace bottom and the loading section on the opposite side, engaging the base centering device of the loading section with the base of the furnace bottom. Then the loading section and receiving section are joined together. Engaging the base centering device with the furnace bottom provides proper centering of the rail loader over the furnace bottom.

While, generally, the crucible block is located in the center of the furnace bottom, it has often been found to have moved some, for example, due to tolerances associated with the pedestals or posts and the inside of the furnace bottom. Therefore, after the rail loader has been centered, the method of the present invention further comprises the step of centering the crucible block within the rails of the loading section using the block centering device. For example, the block centering device can be moved along the rails, engaging the crucible block and thereby moving the block, if necessary, to be located in the center between the rails of the rail loader. The block centering device remains associated with the crucible block until the furnace bottom is raised and until the crucible, with or without a crucible box, is in contact with the crucible block and centered in the furnace bottom.

The crucible, preferably in a crucible box, is then placed onto the carriage unit of the shuttle device. Any means known in the art may be used. In one embodiment of the present invention, the crucible in the crucible box is loaded on the charge loading station, described in more detail above, and then transferred to the shuttle device. Alternatively, the crucible in the crucible box is placed directly onto the carriage unit of the shuttle device. Preferably, in order to permit transport of the crucible on the shuttle device, the carriage unit is temporarily secured or attached to the shuttle of the shuttle device.

The shuttle device and crucible are then placed onto the loading section of the rail loader and, more particularly, placed on the at least one opposing pair of self-centering devices of the loading section of the rail loader. For example, when the self-centering device has an upper bearing and a lower bearing, the shuttle device is placed on the lower bearing. Since, for this embodiment, the self-centering device is pivotably attached to the loading section, the weight of the crucible, crucible box (if used), and shuttle device on the lower bearing causes the self-centering device to pivot until the upper bearing is also in contact with the shuttle device. Since there are opposing pairs of self-centering devices, the weight causes the crucible and shuttle device to shift, moving on the bearings, until it comes to rest in the center of loading section. Thus, the shuttle device is centered simply by placing it on the self-centering devices, and any additional adjustments are optional.

With the rail loader centered over the furnace bottom, the crucible block centered in the rail loader, and the shuttle device holding the crucible self-centered on the rail loader, the method of the present invention further comprises the step of detaching the carriage unit from the shuttle of the shuttle device, if previously attached, and sliding the carriage unit of the shuttle device along the rails of the loading section of the rail loader until it comes to rest over the centered crucible block. As discussed above, any device for allowing the smooth and easy sliding of the carriage unit may be used, including, for example, multiple rollers or bearings.

In order to more precisely center the crucible over the crucible block, at least one carriage stop and/or at least one latch may be provided along at least one rail of the rail loader. The carriage may then be slid along the rails until they contact the stops and secured in place using the latches. The carriage stops and latches can be placed at preset positions along the rails of the rail loader and, more preferably, their positions are adjustable. For example, since the crucible block has been centered, and knowing the relative dimensions of the block centering device and/or the carriage unit, it is possible to calculate the required location of the carriage stops so that, when the carriage comes in contact with the stops, the carriage will be directly over the center of the crucible block. Likewise, the location of the latches can also be calculated. Use of these preset positions enables more precise centering of the crucible in the furnace bottom.

Finally, once centered over the crucible block, the method of the present invention further comprises the step of raising the furnace bottom to contact the crucible block with the crucible or crucible box, if used. With the crucible firmly atop the crucible block, the rail loader can then be removed by sliding the block centering device away from the crucible block and disconnecting the loading section and receiving section of the rail loader. These components can then be moved away, either by carrying them or rolling them if wheels are used, for storage or for use with another furnace.

While the method of the present invention has been described with steps in a particularly order, this represents one embodiment of the method. It will be recognized that several of these steps method can occur in a different order. For example, the step of centering the crucible block may occur after the shuttle device is placed on the rail loader. Furthermore, while it may be preferable to load the crucible with feedstock material prior to placing it on the carriage unit of the shuttle device, the crucible may be loaded at any time prior to placing it in the furnace bottom over the crucible block. Other variations in the order of the steps of the present method are also possible and within the bounds of the present invention.

The present invention further relates to a rail loader system which, preferably, can be used in the method of the present invention. The rail loader system comprises a rail loader and shuttle device, and further optionally comprises a charge loading station. Any of the rail loaders and shuttle devices described in more detail above, and any embodiments of the components of these, can also be used for the rail loader system of the present invention. Furthermore, it will be recognized that the rail loader, shuttle device, and addition components can be prepared using any material of construction known in the art as appropriate for their function.

It has been found that the rail loader system and method of the present invention can enable an operator to place a crucible, especially a crucible loaded with feedstock material, including, for example, silicon, within the center of a furnace with surprising ease and repeatability. These have also been found to be particularly advantageous for larger crucibles, such as those having a height of greater than or equal to about 40 cm, including those having a height of greater than or equal to about 60 cm. Because of their larger sizes, these crucibles can hold a much greater amount of feedstock material and are even more challenging to efficiently load in the center of a furnace. Thus, the method and rail loader system of the present invention have been found to be particularly advantageous for crucibles that contain feedstock material in amounts greater than or equal to about 400 kg, such as greater than or equal to about 500 kg, including greater than or equal to about 600 kg, such as greater than or equal to about 625 kg. Other advantages and benefits will be recognized by one skilled in the art. For example, the rail loader system of the present invention is mobile and can be transported between furnaces, thus allowing an operator to use one rail loader system to load and center a crucible in multiple furnaces.

The foregoing description of preferred embodiments of the present invention has been presented for the purposes of illustration and description. It is not intended to be exhaustive or to limit the invention to the precise form disclosed. Modifications and variations are possible in light of the above teachings, or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. A method of loading a crucible into a furnace comprising the steps of:
1) providing a crucible in a crucible box comprising at least one side plate and a bottom plate, a furnace bottom comprising a crucible block and a base, and a rail loader system comprising:
a) a rail loader, wherein the rail loader comprises a receiving section and a loading section joinable with the receiving section, and wherein the loading section comprises at least one block centering device, at least two rails, at least one opposing pair of self-centering devices, and a base centering device, and
b) a shuttle device comprising a carriage unit on a shuttle;
2) centering the rail loader over the furnace bottom by
i) placing the loading section and the receiving section along opposite sides of the furnace bottom, engaging the base centering device with the base of the furnace bottom, and
ii) joining the loading section and the receiving section together;
3) centering the crucible block within the rails of the loading section with the block centering device;
4) placing the crucible in the crucible box onto the carriage unit of the shuttle device and placing the shuttle device onto the at least one opposing pair of self-centering devices of the loading section of the rail loader;
5) sliding the carriage unit along the rails of the loading section and over the crucible block in the furnace bottom;
6) centering the carriage unit over the crucible block; and
7) raising the furnace bottom to contact the crucible block with the crucible in the crucible box.

2. The method of claim 1, wherein the loading section has two rails having multiple rollers and the block centering device is between the two rails of the loading section.

3. The method of claim 1, wherein the crucible block is square and the block centering device has a shape capable of surrounding the crucible block.

4. The method of claim 2, wherein the step of centering the crucible block within the rails of the loading section comprises sliding the block centering device up against the crucible block.

5. The method of claim 1, wherein the rail loader system further comprises a charge loading station and wherein the step of placing the crucible in the crucible box onto the carriage unit of the shuttle device comprises the steps of:
i) placing the crucible in the crucible box on the charge loading station;
ii) filling the crucible with feedstock material; and
iii) transferring the crucible in the crucible box to the carriage unit of the shuttle device.

6. The method of claim 5, wherein the charge loading station comprises an upper frame and a lower frame, wherein the upper frame is smaller than the lower frame.

7. The method of claim 6, wherein the upper frame is smaller than the bottom plate of the crucible box, and the step of transferring the crucible in the crucible box to the carriage unit of the shuttle device comprises sliding the shuttle device under the bottom plate of the crucible box.

8. The method of claim 1, wherein the loading section comprises 2 opposing pairs of self-centering devices.

9. The method of claim 1, wherein the self-centering device is pivotably attached to the loading section and comprises an upper bearing and a lower bearing.

10. The method of claim 9, wherein the step of placing the shuttle device onto the at least one self-centering device comprises placing the shuttle device onto the lower bearing of the self-centering device.

11. The method of claim 1, wherein the carriage unit is removably attached to the shuttle of the shuttle device.

12. The method of claim 11, wherein the method further comprises the step of detaching the carriage unit from the shuttle of the shuttle device prior to the step of sliding the carriage unit along the rails of the loading section.

13. The method of claim 1, wherein the loading section further comprises at least one carriage stop and at least one latch on at least one rail.

14. The method of claim 13, wherein the step of sliding the carriage unit along the rails of the loading section comprises sliding the carriage unit up to the carriage stops.

15. The method of claim 13, wherein the carriage stops and the latches are adjustable along the rails.

16. The method of claim 15, wherein the carriage stops and the latches are adjusted to preset positions relative to the carriage unit, and wherein the step of centering the carriage unit over the crucible block comprises sliding the carriage unit to the preset positions of the carriage stops and attaching the carriage unit to the latches.

17. The method of claim 1, wherein the method further comprises the step of filling the crucible with feedstock material prior to the step of sliding the carriage unit along the rails of the loading section.

18. The method of claim 17, wherein the feedstock material is silicon.

19. The method of claim 17, wherein the step of filling the crucible with feedstock material comprises filling the crucible with greater than or equal to about 400 kg of feedstock material.

20. The method of claim 17, wherein the step of filling the crucible with feedstock material comprises filling the crucible with greater than or equal to about 500 kg of feedstock material.

21. The method of claim 17, wherein the step of filling the crucible with feedstock material comprises filling the crucible with greater than or equal to about 625 kg of feedstock material.

22. The method of claim 1, wherein the crucible has a height of greater than or equal to about 40 cm.

23. The method of claim 1, wherein the crucible has a height of greater than or equal to about 60 cm.

24. A rail loader system for loading a crucible into a furnace comprising:
1) a rail loader, wherein the rail loader comprises a receiving section and a loading section joinable with the receiving section, and wherein the loading section comprises at least one block centering device, at least two rails, at least one opposing pair of self-centering devices, and a base centering device; and
2) a shuttle device comprising a carriage unit on a shuttle.

25. The rail loader system of claim 24 further comprising a charge loading station, wherein the charge loading station comprises an upper frame and a lower frame and wherein the upper frame is smaller than the lower frame.

26. The rail loader system of claim 24, wherein the loading section has two rails having multiple rollers and the block centering device is between the two rails of the loading section.

27. The rail loader system of claim 24, wherein the block centering device has a shape capable of surrounding a square crucible block in a furnace bottom.

28. The rail loader system of claim 24, wherein the loading section comprises 2 opposing pairs of self-centering devices.

29. The rail loader system of claim 24, wherein the self-centering device is pivotably attached to the loading section and comprises an upper bearing and a lower bearing.

30. The rail loader system of claim 24, wherein the carriage unit is removably attached to the shuttle of the shuttle device.

31. The rail loader system of claim 24, wherein the loading section further comprises at least one carriage stop and at least one latch on at least one rail.

32. The rail loader system of claim 30, wherein the carriage stops and the latches are adjustable along the rails.
